(19) United States
(12) Patent Application Publication
(10) Pub. No.: US 2024/0214748 A1
(43) Pub. Date: Jun. 27, 2024

(54) CONVERTER UNIT FOR ELECTRICAL AND/OR ACOUSTIC SIGNALS AND/OR RELATIVE PRESSURES

(71) Applicant: Robert Bosch GmbH, Stuttgart (DE)

(72) Inventors: Jochen Reinmuth, Reutlingen (DE); Christoph Schelling, Stuttgart (DE)

(21) Appl. No.: 18/542,466

(22) Filed: Dec. 15, 2023

(30) Foreign Application Priority Data
Dec. 21, 2022 (DE) 10 2022 214 252.7

(51) Int. Cl. H04R 19/04

(52) U.S. Cl. CPC H04R 19/04; H04R 2201/003

(57) ABSTRACT

A converter unit for electrical and/or acoustic signals and/or relative pressures. The converter unit includes: a substrate having a cavity, and an interaction unit arranged at least partially and/or completely above the cavity. An internal structure is arranged in a fluid-tight space of the interaction unit. The fluid-tight space is configured to retain a predetermined pressure. The internal structure includes a first layer, and a second layer which is connected to the first layer. The interaction unit is configured to detect and/or generate an acoustic or electrical signal and/or the relative pressure, based on a change in distance between the first layer and/or the second layer and at least one further structure arranged in the fluid-tight space. The interaction unit has a boundary layer which forms a floor and/or ceiling. The first layer and/or the second layer is arranged on the boundary layer by a connecting element.

### CROSS REFERENCE

The present application claims the benefit under 35 U.S.C. § 119 of German Patent Application No. DE 10 2022 214 252.7 filed on Dec. 21, 2022, which is expressly incorporated herein by reference in its entirety.

### FIELD

Some conventional MEMS microphones have a coupled double membrane with an internal counter-electrode. A negative pressure is provided within the double membrane in order thereby to reduce the damping and the thermal noise between the membrane and the counter-electrode. Due to the negative pressure between the two membranes, coupling structures are necessary in order to maintain the distance of the membranes forming the double membrane, which membranes require a relatively large membrane surface.

U.S. Pat. No. 10,560,771 B2 shows a MEMS microphone for detecting sounds by means of such a double membrane.

### BACKGROUND INFORMATION

A converter unit according to the present invention may have an advantage over the related art in that the space required by the converter unit, in particular an overall height of the converter unit, can be reduced by the internal structure. According to an example embodiment of the present invention, the internal structure can optimize the utilization of the chip surface, in particular in that the internal structure is arranged on the boundary layer or membrane by means of the connecting element.

The electrode geometry can thus be designed independently of the boundary layer or membrane. Furthermore, a low-noise acoustic signal can be supplied by means of the converter unit, due to the improved rigidity of the internal structure by means of the second layer. In addition, the converter unit is able to supply a high capacitive signal in the event of a low capacitive basic signal. Furthermore, the converter unit according to an example embodiment of the present invention may have an advantage that high acoustic sensitivity can be mapped by the back plate and the internal structure. In addition, when used as a microphone, the converter unit can have a significantly reduced distortion factor, which can be achieved by a cylinder-head-like movement of the electrodes moved therewith, in particular with the internal structure, with respect to the rigid back plate.

In other words, according to an example embodiment of the present invention, the converter unit comprises a substrate having at least one cavity for electrical and/or acoustic signals and/or relative pressures. The converter unit comprises an interaction unit, wherein the interaction unit is arranged at least partially and/or completely above the cavity, wherein an internal structure is arranged in a fluid-tight space of the interaction unit, wherein the fluid-tight space is configured to retain a predetermined pressure in the fluid-tight space, wherein the internal structure comprises a first layer, wherein the internal structure comprises a second layer which is connected to the first layer, wherein the interaction unit is configured to detect and/or generate the acoustic or electrical signal and/or the relative pressure by means of a change in distance between the first layer and/or the second layer and at least one further structure arranged in the fluid-tight space, wherein the interaction unit comprises at least one boundary layer which forms the floor and/or the ceiling of the fluid-tight space, wherein the first layer and/or the second layer of the internal structure is arranged on the at least one boundary layer by means of a connecting element.

According to an example embodiment of the present invention, preferably, the interaction unit forms a fluid-tight space in which a further structure and the internal structure are arranged. The further structure can in particular be a back plate and/or at least one boundary layer. In this case, the first layer of the internal structure is arranged in particular opposite the back plate. The further structure or the back plate is preferably circular, wherein a star-shaped or beam-shaped recess is arranged in the middle of the circular shape, in which recess the second layer and/or the first layer of the internal structure is arranged. The fluid-tight space preferably has a first boundary layer or a first membrane layer forming the floor of the fluid-tight space, and a second boundary layer or a second membrane layer forming a ceiling of the fluid-tight space. Further preferably, the interaction unit has a type of ridge or the like in the edge region, on which ridge the first or second boundary layer is arranged in order to form the fluid-tight space.

The converter unit for electrical or acoustic signals or relative pressures can, in particular, be designed as a MEMS microphone, MEMS loudspeaker or relative pressure sensor, wherein the MEMS microphone and MEMS loudspeaker, in particular, comprise a recess for pressure compensation.

According to an example embodiment of the present invention, the fluid-tight space is preferably configured to adjust and/or retain a predetermined pressure in the fluid-tight space, wherein the predetermined pressure is in particular lower than an ambient pressure or a low pressure. The first layer preferably forms a movable electrode surface, wherein the interaction unit is configured to detect and/or generate the acoustic signal and/or the relative pressure by means of a change in distance between the first layer and the further structure, for example the back plate and/or the at least one boundary layer. In this case, the further structure is not limited to the back plate and/or the boundary layer, but can also be any other element of the converter unit which is configured to measure a change in distance between the first layer and/or the second layer and the further structure. The converter unit can function as a microphone when detecting and as a loudspeaker when generating. The second layer preferably has a second thickness, which preferably forms stabilizing bars and increases the rigidity or stability of the internal structure.

Furthermore, regions in which a capacitive signal can be generated can be defined with the first layer independently of the second layer. Furthermore, the internal structure can be fastened to the substrate with the aid of an electrically conductive connection in order to provide the internal structure with a specific potential. Furthermore, the connecting element can be arranged on the first layer and/or on the second layer and thus connect the first layer and/or the second layer to at least one boundary layer. This mechanical coupling of the first layer to the boundary layer enables the chip surface to be better used.

Preferred developments of the present invention are disclosed herein.

Preferably, according to an example embodiment of the present invention, the interaction unit has a zero position, wherein, in the zero position, a surface of the second layer and a surface of the back plate are arranged in one plane.

An advantage of this embodiment of the present invention can be that the overall height of the interaction unit or of the converter unit can be reduced by nesting the internal structure in the back plate. The surface of the second layer can preferably be arranged substantially in a plane or planarly relative to the surface of the back plate, while the interaction unit is in a zero position. In other words, the back plate and the second layer can be produced from the same layer material and separated laterally from one another by subsequent etching.

The internal structure preferably has a third layer which is arranged on the second layer, wherein the back plate is arranged at least partially between the first layer and the third layer.

An advantage of this embodiment of the present invention can be that a first measuring capacitance can be formed by means of the first layer and the back plate, and a second measuring capacitance can be formed by means of the third layer and the back plate, so that two mutually independent measuring capacitances can be formed with the aid of the internal structure. The third layer can in particular be arranged opposite the first layer on the second layer. In addition, a particularly low distortion factor of the component results from the change in distance of the electrodes, which is now plane-parallel when the interaction unit is deflected.

According to an example embodiment of the present invention, the second layer and/or an intermediate layer is preferably arranged so as to insulate the first layer from the third layer, in particular electrically.

An advantage of this embodiment of the present invention can be that two mutually independent measuring capacitances can be created with the aid of the insulation by the second layer and/or the intermediate layer the first and the third layer with the back plate.

According to an example embodiment of the present invention, the internal structure is preferably divided into two sections, wherein, in the first section, the interaction unit is configured to detect a signal by means of the first layer and the back plate, and, in the second section, the interaction unit is set up to detect a further signal by means of the third layer and the back plate.

An advantage of this embodiment of the present invention can be that the measurement accuracy can be increased by a differential capacitive measurement in a converter unit or interaction unit.

Preferably, the second layer has at least two recesses for forming at least one strut.

An advantage of this embodiment can be that flat electrodes are formed with the aid of the thin first or third layer, and at the same time a weight of the internal structure can be reduced, with constant rigidity or stability, which is provided by the thick second layer with the struts formed by the recesses. The occurrence of an unfavorable low natural frequency due to too high a weight of the internal structure can thus be avoided, and a high sensitivity of the converter unit can nevertheless be achieved.

According to an example embodiment of the present invention, the cavity preferably has a base area, wherein a distance between the center point of the connecting element and an edge of the base area amounts to at least one quarter of a diagonal of the base area.

An advantage of this embodiment of the present invention is that, with the aid of the cross section of the connecting element, a stiffness of the boundary layer can be configured specifically in relation to the cavity.

The cavity preferably has a base area which is circular, oval and/or square. In this case, the diagonal of the base area is formed between the points of the contour of the base area at the greatest distance from one another.

The internal structure preferably has an inner surface which is arranged in particular concentrically to the center point of the internal structure, wherein a distance between the edge of the base area and the center point of the inner surface amounts to at least one quarter of the diagonal of the base area, wherein the first layer forms up to 10% of the inner surface. Furthermore, the second layer is preferably formed substantially over the entire inner surface.

An advantage of this embodiment of the present invention is that the ratio between the signal and the basic signal can be further improved by reducing the area of the first layer in the vicinity of the center point of the internal structure. Further preferably, the second layer can form up to 10% of the inner surface, in particular by means of struts. This has the advantage of reducing the weight.

Preferably, the first layer has a first thickness and the second layer has a second thickness, wherein the second thickness is greater than the first thickness.

The second thickness is preferably at least twice as large as the first thickness. Further preferably, the second thickness is five times greater than the first thickness. Furthermore, a surface of the first layer is at least twice as large, preferably five times as large, as the surface of the second layer.

Preferably, the further structure is at least one element in the fluid-tight space, selected from the group comprising: a back plate, in particular arranged on the substrate, at least one boundary layer, and/or at least one sub-region of the at least one boundary layer.

An advantage of this embodiment of the present invention is that different measuring capacitances can be formed between the first layer and/or the second layer and the relevant element, such as a back plate, a boundary layer and/or a sub-region of the boundary layer.

The boundary layer preferably has a first sub-region which is arranged on the substrate, wherein the boundary layer has a second sub-region which is arranged above the cavity, wherein the first sub-region and/or the second sub-region is configured to form the at least one further structure.

An advantage of the embodiment of the present invention is that the boundary layer can be arranged to be electrically insulated from the substrate, and a further measuring capacitance can thus be formed.

Further preferably, the connecting element is configured to insulate the first layer and/or the second layer of the internal structure from the at least one boundary layer.

One advantage of this embodiment of the present invention is that the insulation between the internal structure and the boundary layer enables both a capacitance to be formed between the first layer of the internal structure and the back plate and a further capacitance to be formed between the boundary layer and the back plate, since they are insulated from one another. A differential capacitive measurement is thus also possible.

Preferably, the interaction unit is configured to detect and/or generate the acoustic or electrical signal and/or the relative pressure by means of a change in distance between the first and/or third layer and the back plate and/or between the at least one boundary layer and the first layer and/or the third layer.

An advantage of this embodiment of the present invention can be that at least one further capacitance for measuring the acoustic or electrical signals and/or relative pressures can be provided by means of the boundary layer (s) in order to thus further improve the accuracy of the converter unit.

Further preferably, the interaction unit comprises a second boundary layer, wherein at least one support column is arranged between at least the one boundary layer and the second boundary layer.

An advantage of this embodiment of the present invention can be that, with the aid of the support column between the first boundary layer or first membrane and the second boundary layer or second membrane, a movement in the same direction between the first and the second boundary layer is brought about.

Preferably, at least one recess for pressure compensation is arranged between the at least one first boundary layer and the second boundary layer.

An advantage of this embodiment of the present invention can be that a quasi-static pressure equalization between the sound side and the rear volume or the cavity can be provided by means of the channel.

Further preferably, the first layer is arranged at a first distance from the back plate, wherein the first layer is arranged at a second distance from the at least one boundary layer, wherein the first and the second distance is substantially the same.

An advantage of this embodiment is that the linearity of the acoustic signal to be detected and/or of the relative pressure is further improved. In this embodiment, substantially the same means a deviation of +/−50%.

Furthermore, according to an example embodiment of the present invention, the first layer is preferably arranged at a third distance from the second boundary layer, wherein the third distance is substantially at least 1.5 times the first distance.

One advantage of this embodiment of the present invention can be that a signal between the second boundary layer and the back plate is kept small, so that the detection predominates between the first layer and the back plate, and thus a more unique signal can be determined. Substantially, in this embodiment, means a deviation of +/−50%.

Preferably, the at least one boundary layer and/or the first layer has an edge region which is arranged on the substrate in such a way that the at least one boundary layer and/or the first layer can be connected to the substrate in planar fashion.

An advantage of this embodiment of the present invention can be that the signal between the first layer and a boundary layer can be increased with the aid of the edge region without increasing a component size of the converter unit.

Further preferably, the first layer extends substantially completely over the cavity.

An advantage of this embodiment of the present invention can be that the signal which is produced can be further increased with the aid of the first layer without further enlarging the converter unit.

Preferably, the first layer comprises a recess, wherein the recess is configured to arrange the second layer on the at least one boundary layer by means of the connecting element.

An advantage of this embodiment of the present invention can be that the formation of the measuring capacitance can be optimized and limited to regions in which a large change in distance occurs between the internal structure and the boundary layer. In other words, a ratio of measuring capacitance to basic capacitance can be optimized by the recess, so that the signal quality can be further improved.

Further preferably, the at least one boundary layer and the second boundary layer have the same electrical potential.

Preferably, instead of the back plate, at least one dummy structure can be provided, which has a defined electrical potential.

An advantage of this embodiment of the present invention can be that the signal quality between the first layer and the at least one boundary layer and/or the second boundary layer is improved with the aid of the dummy structures.

A further aspect of the present invention relates to a method for producing a converter unit as described above and below, comprising the steps of:
applying and/or structuring a first boundary layer of the converter unit,
applying and/or structuring a first sacrificial layer,
applying and/or structuring a first layer of an internal structure of the converter unit,
applying and/or structuring a second sacrificial layer,
applying and/or structuring a second layer of the first structure of the converter unit,
applying and/or structuring a third sacrificial layer,
applying and/or structuring a second boundary layer of the converter unit,
etching the first, second and/or third sacrificial layer, closing the converter unit,
wherein applying and/or structuring a first boundary layer of the converter unit and/or applying and/or structuring a first sacrificial layer comprises applying and/or structuring a connecting element.

An advantage of this embodiment of the present invention is that the internal structure and the electrode can be designed with the aid of a method, which can lead to a reduction in the production costs of the converter unit.

Further preferably, according to an example embodiment of the present invention, the method comprises an optional step in which a dielectric layer is applied and structured on the substrate.

Furthermore, according to an example embodiment of the present invention, the method comprises the step of applying and/or structuring the first boundary layer, wherein the first boundary layer is preferably electrically conductive, or is conductive in sub-regions. Further preferably, a doped polysilicon layer having a thickness between 150 nm and 3 μm is used to form the first boundary layer.

Further preferably, the first sacrificial layer has an oxide layer with a thickness of 300 nm to 5 μm.

Preferably, the first layer of the internal structure is formed by means of a doped polysilicon layer having a thickness between 50 nm and 5 μm.

Furthermore, the second sacrificial layer consisting of an oxide layer with a thickness of 300 nm to 5 μm can be used. Further preferably, the second layer of the internal structure is formed by means of a doped polysilicon layer having a thickness of 1.5 μm and 50 μm. Furthermore, in the cavity region or in a recess, an inner structuring of the second layer can take place with struts which have a strut width which is less than twice the layer thickness of the third sacrificial layer.

Furthermore, according to an example embodiment of the present invention, the recesses can be filled in the second layer and the subsequent second boundary layer can be applied as a flat layer. The method can comprise a further optional intermediate step which forms and/or structures the third sacrificial layer and removes the silicon region below the third sacrificial layer. In this case, the accesses in the third sacrificial layer can preferably be designed to be so narrow that they can be closed with a further fourth sacrificial layer deposition. In particular, larger regions of the second layer can thus favorably be removed and the second boundary layer can furthermore be formed as a flat structure. Preferably, the third sacrificial layer is an oxide layer having a thickness of 500 nm to 8 μm. Further preferably, the second boundary layer is electrically conductive, or electrically conductive in sub-regions.

Further preferably, according to an example embodiment of the present invention, the second boundary layer is a doped polysilicon layer having a thickness between 150 nm and 3 μm. Furthermore, the closing of the converter unit is a closure method, such as a layer deposition or a laser reseal method, in which a negative pressure is configured between the two boundary layers. Furthermore, the method can comprise the step of etching a cavity into the substrate below the boundary layer, or interaction unit.

Further preferably, according to an example embodiment of the present invention, the step of applying and/or structuring the second layer of the internal structure of the converter unit further comprises, wherein applying and/or structuring the second layer and applying and/or structuring the back plate takes place in a coating step.

An advantage of this embodiment of the present invention can be that the overall height of the converter unit can be reduced further by the simultaneous formation of the back plate and the second layer, and the manufacturing costs of the converter unit can be further reduced.

### BRIEF DESCRIPTION OF THE DRAWINGS

Exemplary embodiments of the present invention are described in detail below with reference to the figures.

FIG. 1 shows a converter unit according to one embodiment of the present invention.

FIG. 2 shows a converter unit according to one embodiment of the present invention.

FIG. 3 shows a converter unit according to one embodiment of the present invention.

FIG. 4 shows a converter unit according to one embodiment of the present invention.

FIG. 5 shows a converter unit according to one embodiment of the present invention.

FIG. 6 shows a converter unit according to one embodiment of the present invention.

FIG. 7 shows a converter unit according to one embodiment of the present invention.

FIG. 8 shows a converter unit according to one embodiment of the present invention.

FIG. 9 shows a flow chart illustrating steps of the method according to one embodiment of the present invention.

### DETAILED DESCRIPTION OF EXAMPLE EMBODIMENTS

The same units, elements and/or components are preferably provided with the same reference signs in all figures.

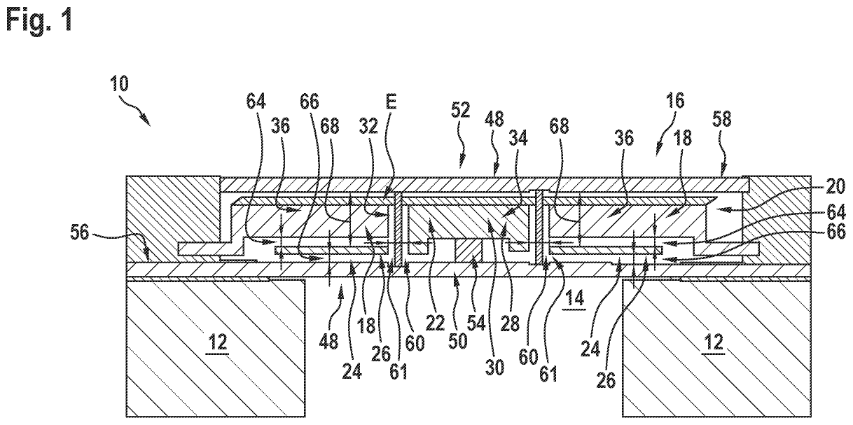

FIG. 1 shows a converter unit 10 according to one embodiment.

The converter unit 10 comprises a substrate 12 in which the cavity 14 is arranged. The converter unit 10 also has an interaction unit 16. In FIG. 1, the interaction unit 16 extends over the entire cavity 14.

Furthermore, the interaction unit 16 forms a fluid-tight space 20. A back plate 18 is arranged in the fluid-tight space 20. Furthermore, an internal structure 22 of the interaction unit 16 is arranged in the fluid-tight space 20. The internal structure 22 comprises a first layer 24. A second layer 28 is arranged on the first layer 24. The first layer 24 has a first thickness 26, wherein the second layer 28 has a second thickness 30. The first thickness 26 is smaller than the second thickness 30, or the second thickness 30 is greater than the first thickness 26. Furthermore, the interaction unit 16 is configured to detect and/or generate the acoustic or electrical signal and/or the relative pressure by means of a change in distance 70 between the first layer 24 and the back plate 18.

The interaction unit 16 also has a zero position 32. In the zero position 32, the converter unit 10 is preferably in a rest position. In the zero position 32, a surface 34 of the second layer 28 and a surface 36 of the back plate 18 are arranged substantially coplanar with one another or lie in one plane.

Furthermore, the surface 34 of the second layer 28 and the surface 36 of the back plate 18 are preferably arranged in one plane, while the converter unit 10 is in the zero position 32. Further preferably, the interaction unit 16 has at least one boundary layer 48. In FIG. 1, the boundary layer 48 forms the floor 50 of the fluid-tight space 20. Furthermore, in FIG. 1, the second layer 28 is arranged on the boundary layer 48 by means of a connecting element 54.

In this case, the connecting element 54 is arranged in particular in an insulating manner with respect to the second layer 28. Furthermore, the interaction unit 16 has a second boundary layer 58. In FIG. 1, the second boundary layer 58 forms the ceiling 52 of the fluid-tight space 20. Preferably, support columns 60 are arranged between the at least one boundary layer 48 and the second boundary layer 58.

Furthermore, the first layer 24 and/or the second layer 28 preferably has at least one recess 61 in which the support columns 60 are arranged. Further preferably, the first layer 24 is arranged at a first distance 64 from the back plate 18. This first distance 64 is substantially equal to a second distance 66 which is arranged between the first layer 24 and the at least one boundary layer 48. Preferably, the first layer 24 is arranged at a third distance 68 from the second boundary layer 58. The third distance 68 can be substantially at least 1.5 times the first distance 64.

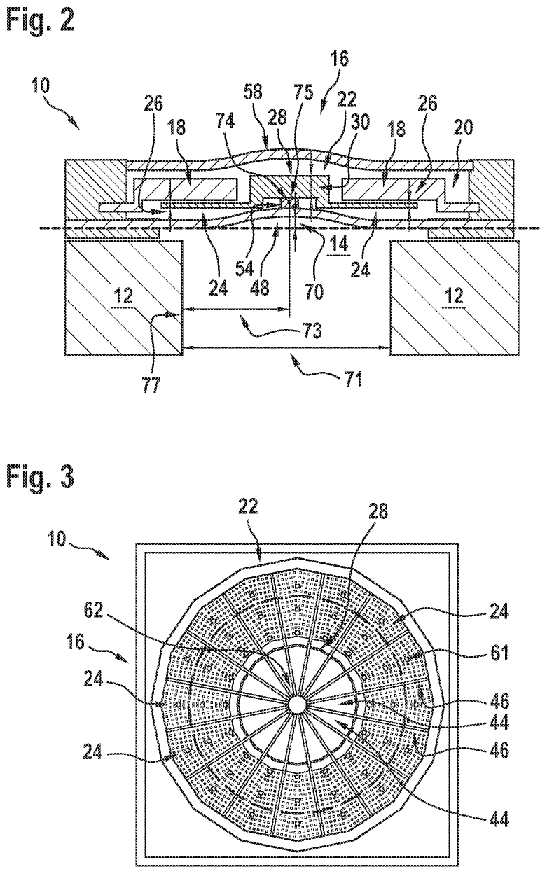

FIG. 2 shows a converter unit 10 according to one embodiment.

The converter unit 10 comprises a substrate 12 having a cavity 14. A first boundary layer 48 is arranged on the substrate 12. Furthermore, the back plate 18 is arranged on the substrate 12. Moreover, the second boundary layer 58 can also be arranged on the substrate 12. The boundary layer 48 and the second boundary layer 58 form at least portions of the fluid-tight space 20. The internal structure 22 and the back plate 18 are arranged in the fluid-tight space 20. The internal structure 22 has a first layer 24 with a first thickness 26. Furthermore, the internal structure 22 has a second layer 28 which has a second thickness 30.

FIG. 2 shows the converter unit 10 in a deflected state, wherein the change in distance 70 represents the deflection of the boundary layer 48 from its zero position 32. In this case, the connecting element 54 can relay the deflection of the boundary layer 48 or change in distance 70 to the internal structure 22 in order thus to detect and/or generate the acoustic or electrical signal or the relative pressure.

The cavity 14 also has a base area 71, which in particular is the cross-sectional area of the cavity 14. The center 75 of the connecting element 54 is arranged at a distance 73 from an edge of the base area 77. The distance 73 is at least one quarter of the diagonal of the base area 71.

FIG. 3 shows a plan view of the converter unit 10 according to one embodiment.

The converter unit 10 has a recess 62 which is arranged in the middle of the converter unit 10 for pressure compensation. Furthermore, the converter unit 10 comprises an interaction unit 16 which comprises the internal structure 22. The internal structure 22 comprises the first layer 24, which is shown as a type of ring in FIG. 3. The first layer 24 has a plurality of perforations 76. Furthermore, the first layer 24 has a recess 61 in which a support column 60 can be arranged. Furthermore, the internal structure 22 comprises a second layer 28. The second layer 28 can have at least two recesses 44. The at least two recesses 44 can form a strut 46. As shown in FIG. 3, a strut 46 can also extend over the first layer 24, so that the stability is increased over the entire surface of the internal structure 22 by means of the strut 46.

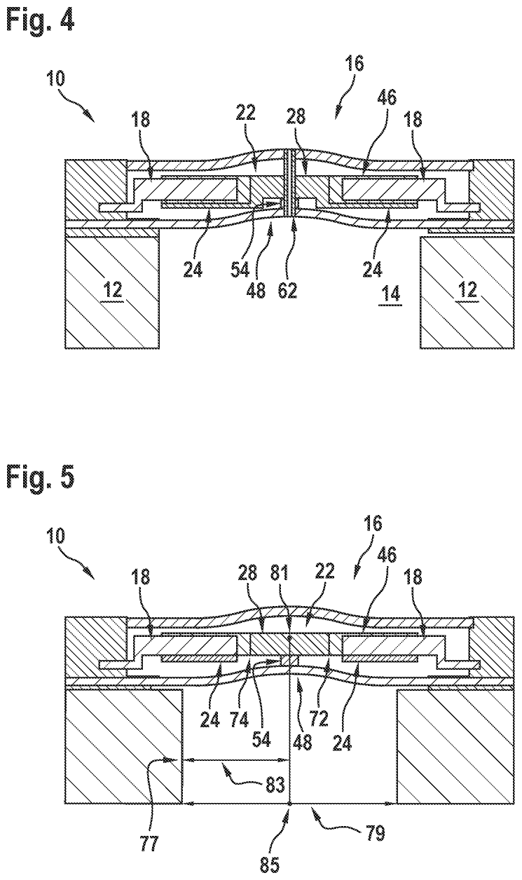

FIG. 4 shows a converter unit 10 according to one embodiment.

In the center of the converter unit 10, the converter unit 10 comprises a recess 62 for pressure compensation. The recess 62 also passes through the connecting element 54. Further preferably, the internal structure 22 has at least one strut 64.

In this case, the strut 64 can be arranged alternately to the back plate 18, so that a back plate 18 is arranged laterally in particular between two struts 46.

FIG. 5 shows the converter unit 10 according to a further exemplary embodiment.

The first layer 24 comprises a recess 74. The recess 74 makes it possible to arrange the connecting element 54 directly on the second layer 28. Further preferably, the first layer 24 forms up to 10% of the area of the cavity 14, wherein the remaining surface can be saved by the recess 74 in the first layer. The connecting element 54, which connects the second layer 28 and the first boundary layer 48 to one another, is arranged in the recess 74. Furthermore, the first layer 24 can be connected to the at least one strut 46. Furthermore, the second layer 28 can in particular form a ring 72 which further increases the stability of the first structure 22.

The internal structure 22 has an inner surface 79, which is arranged in particular concentrically to the center point 81 of the internal structure 22. A distance 83 between the edge of the base area 77 and the center point 85 of the inner surface 79 is at least one quarter of the diagonal of the base area 71. The first layer 24 forms up to 10% of the inner surface 79. Furthermore, the second layer 28 is substantially formed over the entire inner surface 79.

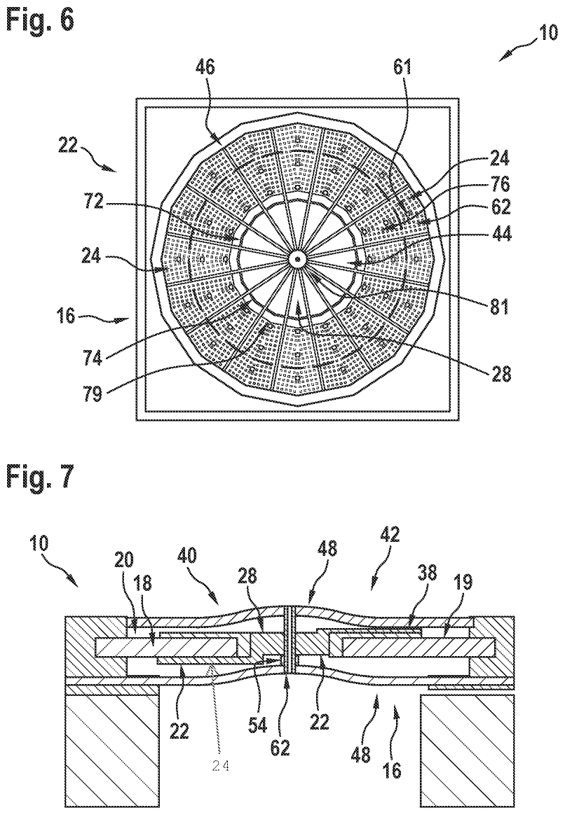

FIG. 6 shows a converter unit 10 according to one embodiment.

The converter unit 10 comprises an internal structure 22 having a first layer 24, which has a recess 74. The second layer 28 comprises a plurality of struts 46 which extend over the entire surface of the internal structure 22. Further preferably, the second layer 28 forms a ring 72. In particular, a recess 44 is arranged between two struts 46, or two recesses 44 form a strut 46. Furthermore, the first layer 24 comprises a plurality of perforations 76. Furthermore, the first layer 24 can have recesses 61 in which support columns 60 are arranged. Furthermore, the internal structure 22 has a center point 80.

FIG. 7 shows an embodiment of the converter unit 10.

The converter unit 10 comprises an interaction unit 16. The interaction unit 16 has a fluid-tight space 20 in which the internal structure 22 is arranged. The internal structure 22 has a first layer 24, a second layer 28 and a third layer 38. The back plate 18 is arranged substantially partially between the first layer 24 and the third layer 38. Further preferably, the interaction unit 16 can have a first type of back plate 18 and a second type of back plate 19, which have different polarities or are electrically insulated from one another. A first capacitance can thus be formed between the first layer 24 and the first type of back plate 18. Furthermore, a second capacitance can be formed between the second type of back plate 19 and the third layer 38. Furthermore, the converter unit 10 has a recess 62. The second layer 28 can be arranged on the boundary layer 48 by means of a connecting element 54. Furthermore, the interaction unit 16 can have a first section 40 and a second section 42.

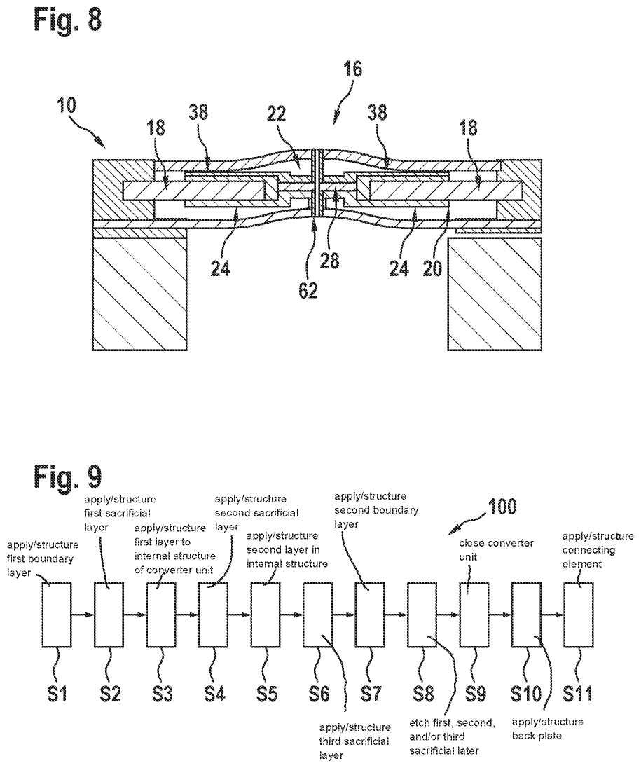

FIG. 8 shows a converter unit 10 according to one embodiment.

The interaction unit 16 of the converter unit 10 comprises an internal structure 22. The internal structure 22 comprises a first layer 24 which is connected to a third layer 38 by the second layer 28. The second layer 28 and/or an insulating intermediate layer is thereby arranged to be insulating between the first layer 24 and the third layer 38.

FIG. 9 shows a flow chart for illustrating steps of the method 100 for producing the converter unit 10. The method 100 has the step of applying and/or structuring S1 a first boundary layer 48 of the converter unit 10. Furthermore, the method 100 comprises the step of applying and/or structuring S2 a first sacrificial layer. Furthermore, the method 100 comprises the step of applying and/or structuring S3 a first layer 24 to the internal structure 22 of the converter unit 10. In addition, the method 100 can comprise the step of applying and/or structuring S4 a second sacrificial layer. Furthermore, the method 100 comprises the step of applying and/or structuring S5 a second layer in the internal structure 22 of the converter unit 10. Furthermore, the method 100 comprises the step of applying and/or structuring S6 a third sacrificial layer.

In addition, the method 100 comprises the step of applying and/or structuring S7 a second boundary layer 58 of the converter unit 10. Furthermore, the method 100 comprises the step of etching S8 the first, second and/or third sacrificial layer. In addition, the method 100 can have the step S9 of closing the converter unit 10. Further preferably, the step of applying and/or structuring S5 the second layer 28 of the first structure 22 of the converter unit 10 comprises the further step of applying and/or structuring S10 a back plate 18 of the converter unit 10. Further preferably, the step of applying and/or structuring S2 the first sacrificial layer comprises applying and/or structuring S11 a connecting element 54.

What is claimed is:

1. A converter unit for an electrical signal and/or acoustic signal and/or relative pressure, comprising:
a substrate having at least one cavity;
an interaction unit arranged at least partially and/or completely above the cavity; and
an internal structure arranged in a fluid-tight space of the interaction unit, wherein the fluid-tight space is configured to retain a predetermined pressure in the fluid-tight space, wherein the internal structure includes a first layer, and a second layer connected to the first layer, wherein the interaction unit is configured to detect and/or generate: (i) the acoustic signal and/or the electrical signal, and/or (ii) the relative pressure, based on a change in distance between: (i) the first layer and/or the second layer, and (ii) at least one further structure arranged in the fluid-tight space;
wherein the interaction unit has at least one boundary layer which forms a floor and/or a ceiling of the fluid-tight space, wherein the first layer and/or the second layer of the internal structure is arranged on the at least one boundary layer using a connecting element.

2. The converter unit according to claim 1, wherein the interaction unit has a zero position, wherein, in the zero position, a surface of the second layer and a surface of a back plate are arranged substantially in a plane.

3. The converter unit according to claim 1, wherein the internal structure includes a third layer which is arranged on the second layer, wherein a back plate is arranged at least partially between the first layer and the third layer.

4. The converter unit according to claim 3, wherein the second layer and/or an intermediate layer is arranged so as to electrically insulate the first layer from the third layer.

5. The converter unit according to claim 3, wherein the internal structure is divided into two sections, wherein, in a first section of the two sections, the interaction unit is configured to detect a signal using the first layer and the back plate, and, in a second section of the two sections, the interaction unit is configured to detect a further signal using the third layer and the back plate.

6. The converter unit according to claim 1, wherein the cavity has a base area, wherein a distance between a center point of the connecting element and an edge of the base area is at least one quarter of a diagonal of the base area.

7. The converter unit according to claim 6, wherein the internal structure has an inner surface which is concentric with a center point of the internal structure, wherein a distance between the edge of the base area and a center point of the inner surface is at least one quarter of the diagonal of the base area, wherein the first layer forms up to 10% of the inner surface.

8. The converter unit according to claim 1, wherein the first layer has a first thickness, wherein the second layer has a second thickness, and wherein the second thickness is greater than the first thickness.

9. The converter unit according to claim 1, wherein the at least one further structure is at least one element in the fluid-tight space, selected from the group comprising: a back plate arranged on the substrate, and/or the at least one boundary layer, and/or at least one sub-region of the at least one boundary layer.

10. The converter unit according to claim 9, wherein the at least one boundary layer has a first sub-region which is arranged on the substrate, wherein the at least one boundary layer has a second sub-region which is arranged above the cavity, wherein the first sub-region and/or the second sub-region is configured to form the at least one further structure.

11. The converter unit according to claim 9, wherein the connecting element is configured to electrically insulate the first layer and/or the second layer of the internal structure from the at least one boundary layer.

12. The converter unit according to claim 9, wherein the interaction unit is configured to detect: (i) the acoustic or the electrical signal, and/or (ii) the relative pressure, based on a change in distance between the at least one boundary layer and the back plate and/or between the at least one boundary layer and the first layer or the second layer.

13. The converter unit according to claim 9, wherein the first layer is arranged at a first distance from the back plate, wherein the first layer is arranged at a second distance from the at least one boundary layer, wherein the first distance and the second distance are substantially the same.

14. The converter unit according to claim 13, wherein the first layer is arranged at a third distance from the at least one boundary layer, wherein the third distance is at least 1.5 times the first distance.

15. A method for manufacturing a converter unit for an electrical signal and/or acoustic signal and/or relative pressure, comprising the following steps:
applying and/or structuring a first boundary layer of the converter unit;
applying and/or structuring a first sacrificial layer;
applying and/or structuring a first layer of an internal structure of the converter unit;
applying and/or structuring a second sacrificial layer;
applying and/or structuring a second layer of the first structure of the converter unit;
applying and/or structuring a third sacrificial layer;
applying and/or structuring a second boundary layer of the converter unit;
etching the first and/or the second and/or the third sacrificial layer; and
closing the converter unit;
wherein (i) the applying and/or structuring of the first boundary layer of the converter unit, and/or (ii) the applying and/or structuring of the first sacrificial layer, includes applying and/or structuring a connecting element.
